(19) United States
(12) Patent Application Publication
(10) Pub. No.: US 2026/0059063 A1
(43) Pub. Date: Feb. 26, 2026

(54) IMAGE READING DEVICE

(71) Applicant: SEIKO EPSON CORPORATION, Tokyo (JP)

(72) Inventors: Yuhei HAMADA, KITAKYUSHU-SHI (JP); Masaki NAMIKI, KITAKYUSHU-SHI (JP); Yasunori FUKUMITSU, KITAKYUSHU-SHI (JP); Masahiro KIMURA, KOGA-SHI (JP); Daiki SATO, FUKUOKA-SHI (JP)

(21) Appl. No.: 19/308,483

(22) Filed: Aug. 25, 2025

(30) Foreign Application Priority Data
Aug. 26, 2024 (JP) 2024-144493

(51) Int. Cl. H04N 1/12; H04N 1/00

(52) U.S. Cl. CPC H04N 1/1215; H04N 1/00602; H04N 1/00745

(57) ABSTRACT

An image reading device includes a tubular-shaped housing, a cylindrical document setting section that is arranged in the housing and on which a document wound in a cylindrical shape is set, an document leading edge inlet into which a leading edge of the document in a rotation direction enters when the document set in the document setting section receives rotational forces RL and RR and rotates, a transport path that is arranged in the housing and along which the document that has entered the document leading edge inlet is transported in a transport direction F by receiving a transport force Cf, a reading section configured to read the image of the document transported along the transport path, and a discharge section to which the document read by the reading section is discharged.

The present application is based on, and claims priority from JP Application Serial Number 2024-144493, filed Aug. 26, 2024, the disclosure of which is hereby incorporated by reference herein in its entirety.

### BACKGROUND

### 1. Technical Field

The present disclosure relates to an image reading device.

### 2. Related Art

An example of an image reading device in the related art of this type is disclosed in JP-A-2020-36272.

A scanner device discloses in JP-A-2020-36272 in which a document is inserted from an document inlet, passes through a reading region of reading means in a housing, and is discharged from a document discharge port along a curved guide member.

In the scanner device described in JP-A-2020-36272, the document is inserted into the inlet in a flat state in a vertical posture. Then, it is taken in from the inlet toward the inside of the housing. Therefore, the operation region required when the document is set in the inlet is required to be a region for the document to be set in addition to the scanner device main body, and the required entire operation region becomes large.

The document in the vertical posture inserted into the inlet is in a cantilever state, and therefore, the posture is unstable. Therefore, while the document is being taken into the housing, the user needs to support the document so that the posture of the document is maintained. This is particularly necessary for a document of a long paper sheet such as a A3 size.

### SUMMARY

In order to solve the above problem, according to an aspect of the present disclosure, an image reading device includes a tubular-shaped housing; a cylindrical document setting section that is disposed in the housing and in which is set a document wound in a cylindrical shape; a document leading edge inlet into which a leading edge of the document set in the document setting section advances in a rotation direction of the document by rotating due to receiving rotational force; a transport path that is disposed in the housing and along which the document that advanced through the document leading edge inlet is transported in a transport direction by receiving a transport force; a reading section configured to read an image of the document transported along the transport path; and a discharge section from which the document read by the reading section is discharged.

### BRIEF DESCRIPTION OF THE DRAWINGS

FIG. 1 is an overall perspective view of an image reading device according to a first embodiment.

FIG. 2 is a plan view of the image reading device according to the first embodiment in a state where a document is set as a left-wound roll.

FIG. 3 is a plan view of the image reading device according to the first embodiment before a document is set.

FIG. 4 schematic is a vertical cross-sectional perspective view of the image reading device according to the first embodiment.

FIG. 5 is an overall perspective view illustrating setting of a document in the image reading device according to the first embodiment.

FIG. 6 is a plan view illustrating a state in which a document is transported in the image reading device according to the first embodiment.

FIG. 7 is a perspective view of a main section corresponding to FIG. 6 of the first embodiment.

FIG. 8 is a perspective view of a main section illustrating how a document is taken out from the image reading device according to the first embodiment.

FIG. 9 is a plan view of the image reading device according to the first embodiment in a state where a document is set as a right-wound roll.

FIG. 10 is a plan view illustrating that the operation region of the entire image reading device according to the first embodiment can be reduced.

### DESCRIPTION OF EMBODIMENTS

Hereinafter, the present disclosure will be briefly described.

In order to solve the above problem, an image reading device according to a first aspect of the present disclosure includes a tubular-shaped housing; a cylindrical document setting section that is disposed in the housing and in which is set a document wound in a cylindrical shape; a document leading edge inlet into which a leading edge of the document set in the document setting section advances in a rotation direction of the document by rotating due to receiving rotational force; a transport path that is disposed in the housing and along which the document that advanced through the document leading edge inlet is transported in a transport direction by receiving a transport force; a reading section configured to read an image of the document transported along the transport path; and a discharge section from which the document read by the reading section is discharged.

Here, the term “cylindrical” in the “cylindrical document setting section” does not require a strictly cylindrical shape, and is used in the sense that the document setting section may be said to be cylindrical as a whole. That is, it may be any member as long as the document is held in a state of being wound in a cylindrical shape in a state where the document in a state of being wound in a cylindrical shape is set in the document setting section, and may include a portion that is not in a cylindrical shape in a part thereof.

According to the present aspect, the cylindrical document setting section that is disposed in the tubular-shaped housing and in which is set a document wound in a cylindrical shape. In other words, the document setting section is formed in a cylindrical shape. Further, the document is not in a flat state but in a state of being wound in a cylindrical shape and is configured to be set in the document setting section having a cylindrical shape.

By this, since the document is set in the document setting section which is also cylindrical in a state of being wound in a cylindrical shape, a region for the document to be set as in the related art is not necessary, and an operation region can be reduced. The document set in the document setting section is not in a cantilever state as in the related art, but is supported over the entire document, and thus the posture of the document is stable, and support by a user as in the related art is not required.

Further, the document set in the document setting section is rotated by a rotational force, and a leading edge of the document in the rotation direction enters the entrance for the leading edge of the document. The document that has entered the document leading edge inlet is transported in the transport direction along the transport path by a transport force, and the reading section reads an image of the document. The transport path and the reading section are arranged in the tubular-shaped housing, similarly to the document setting section. By this, it is possible to reduce the operation region of the entire image reading device.

An image reading device according to the second aspect of the present disclosure is based on the first aspect. The housing has a cylindrical shape.

Here, the term “cylindrical” in “the housing has a cylindrical shape” does not require a strictly cylindrical shape and is used in the sense that the housing can be said to be cylindrical as a whole. That is, besides the cylindrical document setting section, the reading section and the transport path, and the like, are arranged inside, and it is used in the sense that the housing as a whole can be said to have a cylindrical shape. For example, it is used to include an ellipse-shape in plan view.

According to the present aspect, the housing has a cylindrical shape. That is, by designing the cylindrical shape of the housing along the cylindrical shape of the document setting section, it is possible to suppress the occurrence of a wasted space and reduce the operation region of the entire image reading device.

An image reading device according to the third aspect of the present disclosure is based on the second aspect, wherein the discharge section is located outside the document setting section and extends along an inner surface of the housing and includes the inner surface of the housing as part of its structure, and the document to be discharged is curved along the inner surface of the housing.

According to the present aspect, the discharge section is located outside the document setting section, extends along an inner surface of the housing, and the document to be discharged is curved along the inner surface of the housing. That is, the discharge section is provided along the inner surface of the inside of the cylindrical housing, not the outside thereof. By this, a region for the document discharged to the discharge section is not required outside the housing, and thus the operation region can be further reduced.

An image reading device according to the fourth aspect of the present disclosure is based on the third aspect wherein the discharge section is formed with a retrieval section by a part at an upper side of the housing being absent, and the document discharged to the discharge section is configured to take out the document discharged to the discharge section via the retrieval section.

According to the present aspect, the document discharged to the discharge section is configured to take out the document discharged to the discharge section via the retrieval section. This makes it easy to take out the document discharged to the discharge section.

An image reading device according to the fifth aspect of the present disclosure is based on the fourth aspect, wherein the retrieval section is formed by an upper side to a lower side of the housing being absent in a curved shape.

According to the present aspect, the retrieval section is formed by an upper side to a lower side of the housing being absent in a curved shape. By this, with this configuration, the document discharged to the discharge section has the exposed region formed in with curved shape, and thus the document can be taken out more easily.

An image reading device according to the sixth aspect of the present disclosure is based on the fourth aspect, wherein the document setting section includes a cylindrical peripheral wall, a set guide arranged inside the peripheral wall and protruding upward, and a set opening that is between the upper section of the set guide and the upper section of the peripheral wall through which the document is inserted toward the lower section. Further, it is configured such that the document wound in a cylindrical shape is set in a region between the set guide and an inner surface of the peripheral wall by being inserted into the set opening and advances into the document leading edge inlet by receiving the rotational force.

Note that the present aspect may be dependent on any one of the second aspect to the fifth aspect.

According to the present aspect, the document setting section includes the cylindrical peripheral wall, the set guide arranged inside the peripheral wall, and the set opening for inserting the document. By this, the document in a state of being wound in a cylindrical shape can be inserted into the document setting section from the set opening such that the set guide is positioned at the center of the cylindrical document, and thus the user can easily set the document.

The document in a state of being wound in a cylindrical shape is set in a region between the set guide and the peripheral wall by being inserted from the set opening. The document in the state of being wound in a cylindrical shape tends to return to a flat state by a restoring force if there is nothing to maintain the wound state. Therefore, the document in the set state spreads out toward the inner surface of the peripheral wall by the restoring force based on the fact that the document is wound in the cylindrical shape and is in a state of being in contact with the inner surface of the peripheral wall. By this, the set state of the document set in the document setting section is stabilized, and the leading edge can enter the document leading edge inlet by rotating the document in the stabilized state.

An image reading device according to the seventh aspect of the present disclosure is based on the sixth aspect and includes a rotation applying section that applies the rotational force to the document set in the document setting section.

According to the present aspect, the rotation applying section is configured to apply the rotational force to the document set in the document setting section. By this, the document is set in the document setting section, and the rotational force is applied from the rotation applying section in a stable state where the document is in contact with the inner surface of the peripheral wall. In this manner, the document, being in a stable state, effectively receives the rotational force from the rotation applying section and smoothly enters the document leading edge inlet.

An image reading device according to the eighth aspect of the present disclosure is based on the sixth aspect, wherein a gap between the set guide and the inner surface of the peripheral wall decreases from one end of the set guide to an other end.

Note that the present aspect may also be according to the seventh embodiment.

According to the present aspect, a gap between the set guide and the inner surface of the peripheral wall decreases from one end of the set guide to an other end. In other words, for example, the set guide is configured such that the outer diameter of the upper section is small, and the outer diameter increases toward the lower section. By this, when the document in a state of being wound in a cylindrical shape is inserted from the set opening toward the bottom section, the document is easily inserted because the outer diameter of the upper section of the set guide is small. Since the outer diameter of the set guide increases toward the lower section, the document inserted in a state of surrounding the set guide from the periphery receives a force in a direction in which the diameter of the cylindrical document increases, that is, a force in a direction in which the document expands, due to the increase in the outer diameter of the set guide. By this, it is easier for the outer peripheral surface of the document wound in a cylindrical shape to come into contact with the inner surface of the peripheral wall.

An image reading device according to the ninth aspect of the present disclosure is based on the first aspect, wherein the document leading edge inlet includes a first entrance and a second entrance through which the document enters depending on a direction in which the document is wound when the document is rotated by receiving the rotational force.

Here, the “winding direction of the document” means whether the document is wound as a right-wound direction or a left-wound direction in a plan view in a state where the document wound in a cylindrical shape is set in the document setting section. Here, the definitions of the right-wound and left-wound will be described later.

Note that the present aspect may be according to any one of the second aspect to the eighth aspect.

According to the present aspect, the document leading edge inlet includes a first entrance and a second entrance. The document is fed into either entrance depending on the winding direction in which it rotates when rotational force is applied. By this, the user can put the document into the document setting section without caring about the winding direction of the document wound in a cylindrical shape, and thus handling is easy.

An image reading device according to the tenth aspect of the present disclosure is based on the ninth aspect and further includes rotation applying section configured to apply a rotational force in both clockwise and counterclockwise directions to the document set in the document setting section, wherein a leading edge of the document rotated by the rotation applying section enters the first entrance or the second entrance.

According to the present aspect, the rotation applying section can apply a rotational force in both the counterclockwise direction and the clockwise direction to the document set in the document setting section. Then, the leading edge of the document rotated by the rotation applying section enters the first entrance or the second entrance. By this, the user can cause the leading edge of the document to enter the first entrance or the second entrance by the rotation of the rotation applying section by inserting the document into the document setting section without caring about the winding direction of the document in a state of being wound in a cylindrical shape.

Further, the document is set in the document setting section, and the rotational force is applied from the rotation applying section in a stable state in which the document is in contact with the inner surface of the peripheral wall. That is, when the document is set in the document setting section in a stable state and is receiving rotational force from the rotation applying section, the rotational force is transmitted more effectively to the document, allowing it to smoothly enter the document leading edge inlet.

An image reading device according to the eleventh aspect of the present disclosure is based on the tenth aspect, wherein the first entrance includes a first detection section that detects entry of a leading edge of the document, the second entrance includes a second detection section that detects entry of a leading edge of the document, and when both the first detection section and the second detection section are in a non-detection state at a point in time when a predetermined time elapses after the clockwise or counterclockwise rotational force is applied to the document, then direction of the rotational force is controlled to switch to the opposite direction.

According to the present aspect, the first detection section is provided at the first entrance, and the second detection section is provided at the second entrance. When both the first detection section and the second detection section are in the non-detection state at a time point when a predetermined time has elapsed after the counterclockwise or clockwise rotational force is applied to the document, a control section controls the direction of the rotational force to be switched to the opposite direction. By this, the user can automatically cause the leading edge of the document to enter the first entrance or the second entrance by the rotation of the rotation applying section by inserting the document into the document setting section without caring about the winding direction of the document in a state of being wound in a cylindrical shape.

An image reading device according to the twelfth aspect of the present disclosure is based on the ninth aspect. The transport path includes a first transport path having the first entrance and a second transport path having the second entrance. A downstream end of the first transport path and a downstream end of the second transport path merge in the transport direction to form a third transport path. The reading section is arranged on the third transport path.

Note that the present aspect can also be according to the tenth aspect or the eleventh aspect.

According to the present aspect, the downstream end of the first transport path and the downstream end of the second transport path merge in the transport direction to form the third transport path and the reading section is arranged on the third transport path. By this, the leading edge of the document in a state of being wound in a cylindrical shape enters the first entrance or the second entrance according to the winding direction, but the first transport path and the second transport path merge and are transported in the third transport path which is a common transport path. Therefore, the image reading device can be downsized as compared with a configuration in which a transport path is arranged for each winding direction of the document.

The reading section reads an image of the document transported along the third transport path that is the common transport path. By this, both the document entering from the first entrance and the document entering from the second entrance are read by the reading section while being transported along the third transport path. That is, the image reading of the document entering from the first entrance and the image reading of the document entering from the second entrance can be performed under the same conditions.

An image reading device according to the thirteenth aspect of the present disclosure is based on the twelfth aspect. The reading section includes a first reading section configured to read an image on a first surface of the document and a second reading section configured to read an image on a second surface of the document. In plan view with respect to a straight line passing through the third transport path, the first reading section and the second reading section are arranged symmetrically with respect to the line passing through the third transport path. The first transport path and the second transport path are arranged symmetrically with respect to the line, and the center of the cylindrical set guide is located on the straight line.

According to the present aspect, the first reading section and the second reading section are arranged symmetrically with respect to the line passing through the third transport path, and the first transport path and the second transport path are arranged symmetrically with respect to the line and passing through the third transport path in plan view. Further, the center of the cylindrical set guide is located on the straight line. By this, as both the left-wound roll and the right-wound roll, the document is arranged line-symmetrically with respect to the winding direction of the document, so that the document transport property can be stabilized.

### EMBODIMENTS

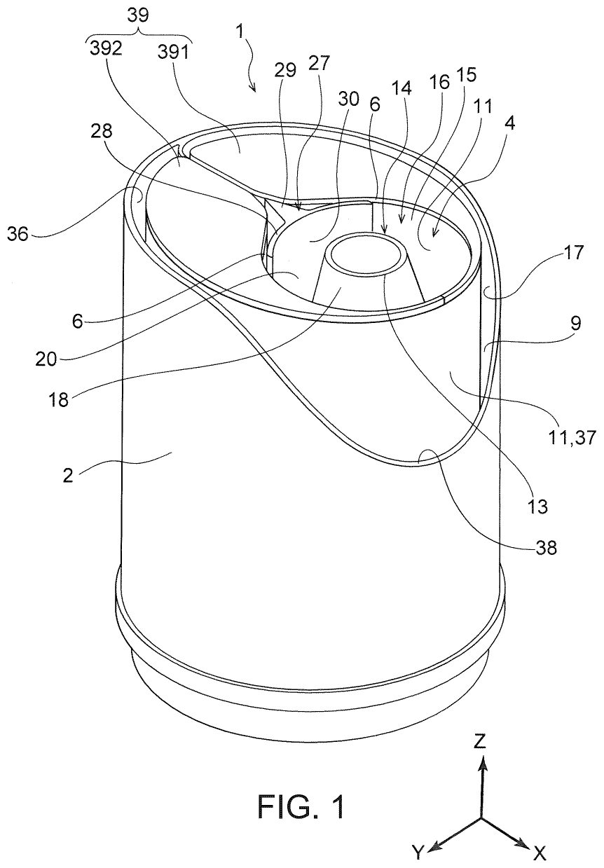

Hereinafter, an image reading device according to an embodiment of the present disclosure will be described in detail with reference to FIGS. 1 to 10.

In the following description, three axes orthogonal to each other are referred to as an X-axis, a Y-axis, and a Z-axis, respectively, as shown in each drawing. The direction indicated by the arrows of the three axes (X, Y, and Z) is the +direction of each direction, and the opposite direction is the −direction. The Z-axis direction corresponds to a vertical direction, that is, a direction in which gravity acts, a +Z direction indicates a vertically upward direction, and a −Z direction indicates a vertically downward direction. The X-axis direction and the Y-axis direction correspond to horizontal directions. The +Y direction indicates the direction to the front of the device and the −Y direction indicates the direction to the rear of the device. The +X direction indicates the direction to the right of the device and the −X direction indicates the direction to the left of the device.

The image reading device of the present embodiment is a scanner capable of reading an image of a document. Here, an image refers to an image visually recorded on a document, for example, a character, a figure, a table, a picture, or a photograph.

The document may be a sheet-like material that can be wound into a cylindrical shape, and is, for example, a A4 paper sheet, a A3 paper sheet, or the like on which the image is recorded.

### First Embodiment

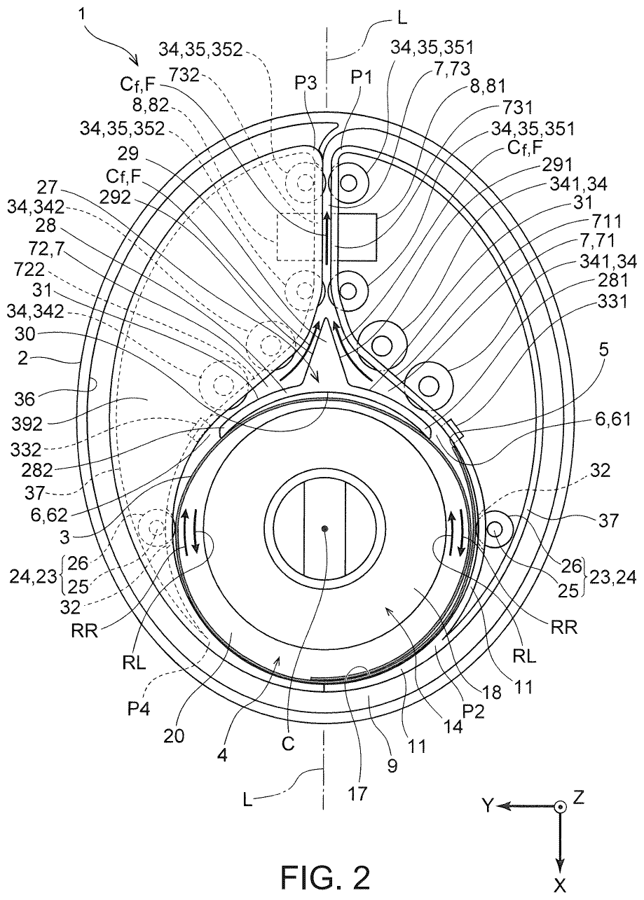

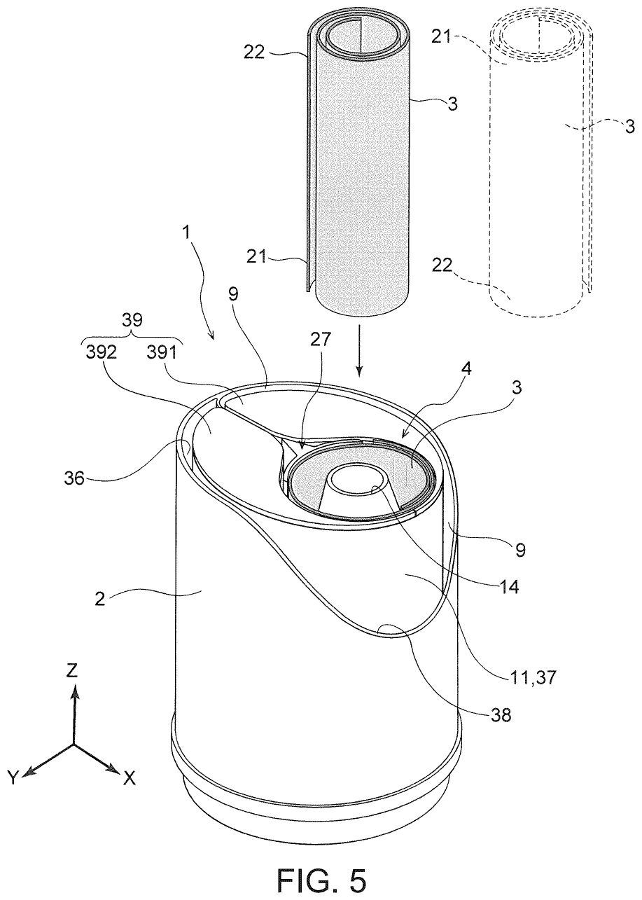

As illustrated in FIGS. 1 to 5, an image reading device 1 according to the first embodiment includes a tubular-shaped housing 2, a cylindrical document setting section 4 that is arranged in the housing 2 and on which a document 3 (see FIGS. 2 and 5) wound in a cylindrical shape is set, and a document leading edge inlet 6 into which a leading edge 5 of the document 3 set in the document setting section 4 enters in a rotation direction of the document 3 by the document receiving rotational forces RL and RR and rotating.

The image reading device 1 further includes a transport path 7 that is arranged in the housing 2 and along which the document 3 that has entered the document leading edge inlet 6 is transported in a transport direction F by receiving a transport force Cf, a reading section 8 configured to read the image of the document 3 transported along the transport path 7, and a discharge section 9 on which the document 3 that was read by the reading section 8 is discharged.

### Housing

As illustrated in FIG. 1, the image reading device 1 according to the present embodiment includes the tubular-shaped housing 2 as a constituent member forming the outer appearance. In the present embodiment, the housing 2 is formed in a cylindrical shape. Here, the term “cylindrical” in the housing 2 formed in a cylindrical shape does not require a strictly cylindrical shape and is used in this specification to mean that the housing 2 can be said to have a cylindrical shape as a whole. For example, the shape may be elliptically tubular-shaped in plan view. The tubular-shaped housing 2 is not limited to a cylindrical shape and may be a polygonal tubular shape such as a square tubular shape.

In the present embodiment, the upper section of the housing 2 is open upward. A cap (not shown) may be provided on the upper section of the housing 2. By this, when the image reading device 1 is not used, the opened upper section is covered with the cap, and the inside can be protected. The cap is also preferably formed in a cylindrical shape similar to the housing 2 so that the appearance of the image reading device 1 is formed in a cylindrical shape as a whole.

### Document Setting Section

As illustrated in FIGS. 1 to 5, the image reading device 1 includes the document setting section 4 arranged in the housing 2. As described above, the document setting section 4 is formed in a cylindrical shape so that a document wound in a cylindrical shape can be set.

Here, the document setting section 4 being “cylindrical” does not require that the document setting section 4 is strictly cylindrical, and it is sufficient that the document setting section 4 is cylindrical as a whole. In other words, in a state where the document 3 in a state of being wound in a cylindrical shape is set in the document setting section 4, the document 3 may be maintained in a state of being wound in a cylindrical shape, and a portion which is not in a cylindrical shape may be included in a part thereof.

In the present embodiment, the document setting section 4 includes a cylindrical peripheral wall 11, a set guide 14, and a set opening 16.

The set guide 14 is arranged in the cylindrical peripheral wall 11 so as to protrude upward from below. The cylindrical peripheral wall 11 has a bottom section 19, and the set guide 14 is fixed to the bottom section 19.

The set opening 16 is an opening for inserting the document 3 toward a lower section 12 of the set guide 14 between an upper section 13 of the set guide 14 and an upper section 15 of the peripheral wall 11.

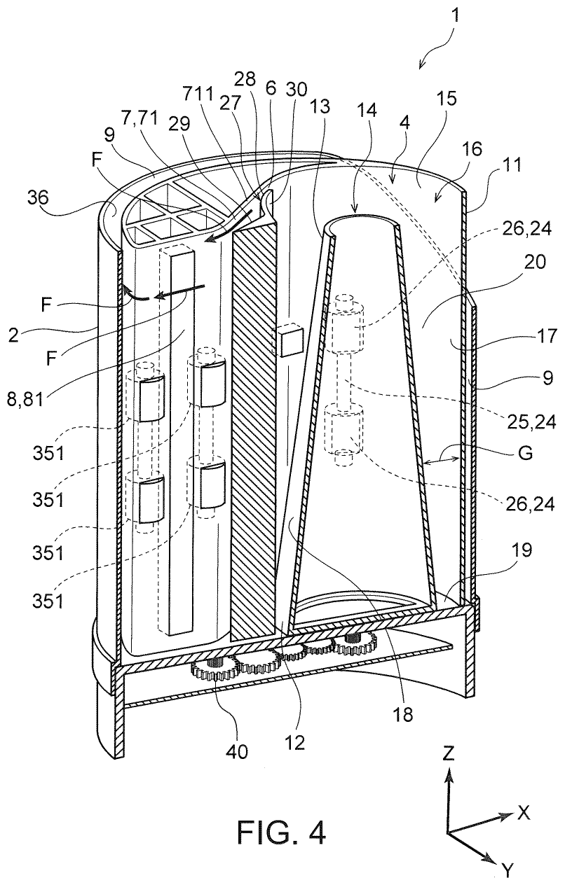

As shown in FIG. 4, the gap G between an outer surface 18 of the set guide 14 and an inner surface 17 of the peripheral wall 11 gradually decreases from the top as one side to the bottom as the other side. In other words, in the present embodiment, the gap G is formed by forming the outer surface 18 of the set guide 14 in a conical shape.

As shown in FIG. 5, the document 3 in a state of being wound in a cylindrical shape is inserted downward from the set opening 16, and is set in a region 20 between the set guide 14 and the inner surface 17 of the peripheral wall 11. The document 3 in the state of being wound in a cylindrical shape tends to return to a flat state by a restoring force unless there is something that maintains the wound state. Therefore, the document 3 in the set state spreads toward the inner surface 17 of the peripheral wall 11 by the restoring force and is in contact with the inner surface 17 of the peripheral wall 11.

The document 3 wound into a cylindrical shape and set in region 20 of the document setting section 4 receives rotational forces RL and RR (described later). As a result, the leading edge 5 of the document 3, in the rotation direction, enters the document leading edge inlet 6.

The document 3 in the state of being wound in a cylindrical shape can be easily made by winding the flat state document 3 by hand, for example. The document 3 in a state of being wound in a cylindrical shape is wound as a left-wound or a right-wound direction depending on a direction in which the document 3 is inserted into the set opening 16. That is, as shown in FIG. 5, when the document 3 in a state of being wound in a cylindrical shape is given a reference numeral 21 at one end and a reference numeral 22 at the other end, if the document 3 is inserted in a posture with the one end 21 facing downward and the other end 22 facing upward, the document 3 is set as a left-wound roll. In contrast, when the document 3 is inserted with the other end 22 facing down, the document 3 is set as a right-wound roll. Here, left-wound roll is defined as a state in which the document 3 in the wound state is wound leftward from the center side toward the outside as indicated by a solid line in FIG. 5, that is, a state in which the document 3 is wound counterclockwise, and the right-wound roll is defined as a state in which the document 3 is wound rightward from the center side toward the outside as indicated by a dashed line in FIG. 5, that is, a state in which the document 3 is wound clockwise.

### Document Leading Edge Inlet

In the present embodiment, the following configuration is adopted so that the leading edge 5 of the document 3 can be inserted into the document leading edge inlet 6 regardless of whether the document 3 is set in the document setting section 4 as a left-wound or right-wound roll.

First, as shown in FIG. 2, the document leading edge inlet 6 includes a first entrance 61 and a second entrance 62 into which the leading edge 5 of the document 3 enters according to the winding direction of the document 3 that rotates by receiving rotational forces RL and RR (to be described later), that is, according to whether the document 3 is wound as the left-wound or the right-wound roll.

The transport path 7 includes a first transport path 71 having the first entrance 61 and a second transport path 72 having the second entrance 62. A downstream end of the first transport path 71 in the transport direction F and a downstream end of the second transport path 72 are configured to join each other to form a third transport path 73. The third transport path 73 is a straight path. The reading section 8 is arranged on the third transport path 73, which is a straight path.

The first entrance 61 and the second entrance 62 are formed by an entrance forming member 27 and the inner surface 17 of the peripheral wall 11. The entrance forming member 27 includes a base section 28 and a guide section 29. The base section 28 is arranged to face the set guide 14 and has a concave surface 30.

The concave surface 30 and the inner surface 17 of the peripheral wall 11 constitute the substantially circular set opening 16 of the document setting section 4. As shown in FIGS. 1 and 4, the concave surface 30 and the inner surface 17 of the peripheral wall 11 constitute the region 20 of the document setting section 4 where the document 3 is set.

In present embodiment, the first entrance 61 is formed as a gap, that is, an opening, created by a first end portion 281 of the base section 28 separated from and facing the inner surface 17 of the peripheral wall 11. The second entrance 62 is formed as a gap, that is, an opening, created by a second end portion 282 of the base section 28 separated from and facing the inner surface 17 of the peripheral wall 11.

The guide section 29 is integrally provided in a protruding manner on a convex surface 31 on the opposite side to the concave surface 30 of the base section 28 and at a position on a straight line L passing through the third transport path 73. In other words, the guide section 29 is arranged at the center in the horizontal direction (Y-axis direction) intersecting the direction of the straight line L (X-axis direction) of the base section 28. The guide section 29 has a shape tapered in the transport direction F.

A first surface 291 forming one surface of the tapered shape of the guide section 29 constitutes a part of the first transport path 71 together with the convex surface 31 of the base section 28. A second surface 292 forming the other surface of the tapered shape of the guide section 29 constitutes a part of the second transport path 72 together with the convex surface 31 of the base section 28.

The peripheral wall 11 is integrally connected to a first path component member 711 that forms a part of the first transport path 71 at the first entrance 61. The first path component member 711 is further integrally connected to one third path component member 731 of the third transport path 73.

The peripheral wall 11 is integrally connected to a second path component member 722 that forms the second transport path 72 at the second entrance 62. The second path component member 722 is further integrally connected to the other third path component member 732 of the third transport path 73.

### Rotation Applying Section

In the present embodiment, the document setting section 4 includes a rotation applying section 23 that applies a rotational force to the document 3 set in the region 20. The rotation applying section 23 is configured to be able to apply the document 3 with a left-handed rotational force RL in a counterclockwise direction and a right-handed rotational force RR in a clockwise direction by switching between the rotational forces RL and RR in both directions. The rotation applying section 23 is provided at two positions spaced apart by about 180 degrees in the circumferential direction in the horizontal plane.

The rotation applying section 23 is configured by providing a rotation roller 24 on the peripheral wall 11 as a specific structure. A through hole 32 is provided in the peripheral wall 11. A part of the rotation roller 24 protrudes from the inner surface 17 of the peripheral wall 11 through the through hole 32 so as to be able to come into contact with the surface of the document 3.

The rotation roller 24 has a roller 26 fixed to a rotation shaft 25 provided along the Z-axis direction. Two or more rollers 26 are fixed to the rotation shaft 25 so as to be spaced apart from each other in the Z-axis direction. The rotation of the rotation shaft 25 causes the roller 26 to rotate integrally. The rotation shaft 25 is rotated by the power of rotation transmitted from a motor (not shown).

As shown in FIG. 4, two rollers 26 are provided at positions below the upper section 13 and above the lower section 12 of the set guide 14 in the Z-axis direction.

As described above, it is a configuration in which the document 3 in a state of being wound in a cylindrical shape receives the rotational forces RL and RR (see FIG. 2) in a state of being set in the region 20 of the document setting section 4, so that the leading edge 5 in the rotation direction of the document 3 advances into the first entrance 61 or the second entrance 62 of the document leading edge inlet 6.

In the present embodiment, the first entrance 61 is provided with a first detection section 331 that detects the entry of the leading edge 5 of the document 3. The second entrance 62 is provided with a second detection section 332 that detects the entry of the leading edge 5 of the document 3. Here, mechanical lever sensors are adopted as the first detection section 331 and the second detection section 332, but this is not a limitation, and they may be, for example, optical-type sensors or the like.

If both the first detection section 331 and the second detection section 332 are in a non-detection state after a predetermined time elapsed since the counterclockwise rotational force RL or the clockwise rotational force RR is applied to the document 3, then the direction of the rotational force is controlled to switch to the opposite direction by a control section (not shown). The predetermined time is set to a rotation time required for the leading edge 5 of the document 3 to rotate one or more times.

Here, if the first detection section 331 is in the non-detection state at after the predetermined time elapsed since the counterclockwise rotational force RL is applied to the document 3, then the direction of the rotational force is switched to the clockwise rotational force RR, which is the opposite direction.

The control section controls the operation of the rotation applying section based on the detection information of the first detection section 331 and the second detection section 332. The control section further controls a transport operation by a transport section 34 and a reading operation of an image of the document 3 by the reading section 8 (to be described later).

The control section includes a CPU, a flash ROM, and a RAM. The CPU performs various calculation processes according to a program stored in the flash ROM and controls the operation of the entire image reading device 1. The flash ROM, which is an example of the storage unit, is a nonvolatile memory that can be read from or written into. Various kinds of information are temporarily stored in the RAM, which is an example of the storage unit.

An operation panel (not shown) is arranged on the housing 2 of the image reading device 1. For example, an operation panel that can be curved along the outer peripheral surface of the housing 2 is arranged.

### Transport Path

As illustrated in FIG. 2, the transport path 7 is provided with the transport section 34 that applies a transport force Cf for transporting the document 3 in the transport direction F. The transport section 34 is configured by transport rollers. As the transport section 34, a first transport roller 341 is provided in the first transport path 71. The first transport rollers 341 are provided at two positions along the transport direction F. Further, as the transport section 34, second transport rollers 342 are provided in the second transport path 72. The second transport rollers 342 are provided at two positions along the transport direction F.

The first transport rollers 341 are provided in a state of being able to contact the document 3 via a through hole (not shown) formed in the first path component member 711 and can apply a transport force Cf to the document 3. The second transport rollers 342 are provided in a state of being able to contact the document 3 via a through hole (not shown) formed in the second path component member 722 and can apply a transport force Cf to the document 3.

The first transport rollers 341, 341 are arranged so as to contact the document 3 entering the first entrance 61 from the same sides as the rotation rollers 24. In the first transport path 71, the document 3 spreads out by the restoring force caused by being wound in a cylindrical shape and is in contact with the first transport rollers 341, 341. Therefore, a transport force Cf by the rotation of the first transport rollers 341, 341 is applied to the document 3, and the document 3 can be fed in the transport direction F.

The second transport rollers 342, 342 are also arranged so as to contact the document 3 entering the second entrance 62 from the same sides as the rotation rollers 24. In the second transport path 72, the document 3 spreads out by the restoring force caused by being wound in a cylindrical shape and is in contact with the second transport rollers 342, 342. Therefore, a transport force Cf from the rotation of the second transport rollers 342, 342 is applied to the document 3, and the document 3 can be fed in the transport direction F.

As the transport section 34, a third transport roller pair 35 that applies a transport force Cf by nipping the document 3 from both sides is further provided in the third transport path 73 which is a straight path. The third transport roller pairs 35 are provided at two locations along the transport direction F.

As the third transport roller pair 35, one third transport roller 351, which is one of the pair, is provided in one third path component member 731, which forms the third transport path 73. One third transport roller 351 is provided in a state of being able to contact one of surface of the document 3 via a through hole (not shown) formed in one of the third path component member 731.

Further, as the third transport roller pair 35, the other third transport roller 352, which is the other of the pair, is provided in another third path component member 732, which forms the third transport path 73. The other third transport roller 352 is provided in a state of being able to contact the other surface of the document 3 via a through hole (not shown) formed in the other third path component member 732.

The first transport roller 341, the second transport roller 342, and the third transport roller pair 35 are rotated by the rotation power transmitted from a motor (not shown) via a gear train 40 forming a power transmission mechanism. The gear train 40 is arranged further below the bottom section 19 of the peripheral wall 11. The image reading device 1 of the present embodiment is configured with a low centroid by placing heavy weight components such as the gear train 40, the drive motor and the like at the lower section, making it difficult to tip over.

In present embodiment, both the third transport roller 351 and the third transport roller 352 are drive rollers that rotate by the transmission of power, but one of them may be configured as a driven roller.

As shown in FIG. 2, the reading section 8 includes a first reading section 81 that reads an image on a first surface of the document 3, and a second reading section 82 that reads an image on a second surface on the opposite side than the first surface. The first reading section 81 is arranged between one of third transport rollers 351, 351, which is one of the two transport rollers provided at the two locations, in the transport direction F. Similarly, the second reading section 82 is also arranged between the other third transport rollers 352, 352, which is the other of the two arranged at the two positions in the transport direction F.

A document detection section (not shown) is provided downstream from the position where the first transport path 71 and the second transport path 72 of the transport path 7 merge, and upstream from the third transport roller pair 35. In the third transport path 73, where the reading section 8 reads the image of the document 3, the document 3 is transported with a high degree of accuracy based on the position information of the leading edge 5 of the document 3 sensed by the document detection section.

### Discharge Section

As illustrated in FIGS. 1 to 5, in the present embodiment, the discharge section 9 is located outside the document setting section 4 and along an inner surface 36 of the housing 2. The discharge section 9 is configured to be present over the entire circumference along the inner surface 36 of the housing 2. The discharge section 9 is connected to the third transport path 73. The discharge section 9 includes the inner surface 36 of the housing 2 as a part of a component and includes a partition surface section 37.

The partition surface section 37 is configured to be present over the entire circumference along the inner surface 36 of the housing 2. The partition surface section 37 is partially formed by using the outer surface of the peripheral wall 11. That is, a part of the partition surface section 37 is integrally connected to one of the third path component members 731 at a connection point P1 and is further integrally connected to the peripheral wall 11 at a connection point P2. The other of the partition surface sections 37 is integrally connected to the other of third path component members 732 at a connection point P3 and is further integrally connected to the peripheral wall 11 at a connection point P4.

That is, the document 3 discharged from the third transport path 73 to the discharge section 9 is guided to curve along the inner surface 36 of the housing 2 in the region between the inner surface 17 of the housing 2 and the partition surface section 37.

As shown in FIGS. 1 and 5, in the present embodiment, the discharge section 9 is formed with a retrieval section 38 by a part at an upper side of the housing 2 being absent. The document 3 discharged to the discharge section 9 can be taken out from the retrieval section 38. Specifically, the retrieval section 38 is formed by an upper side to a lower side of the housing 2 being absent in a curved shape. By this, as shown in FIG. 1, the partition surface section 37 is exposed to the outside at a portion corresponding to the retrieval section 38.

In the present embodiment, a cover 39 is installed on the upper surface of the partition surface section 37 forming the discharge section 9. In a state where the cover 39 is installed, the portion of the set opening 16 of the document setting section 4 and the upper section of the discharge section 9 are opened. Here, the cover 39 is divided into two, a first cover 391 and a second cover 392, but may be integrally formed without being divided.

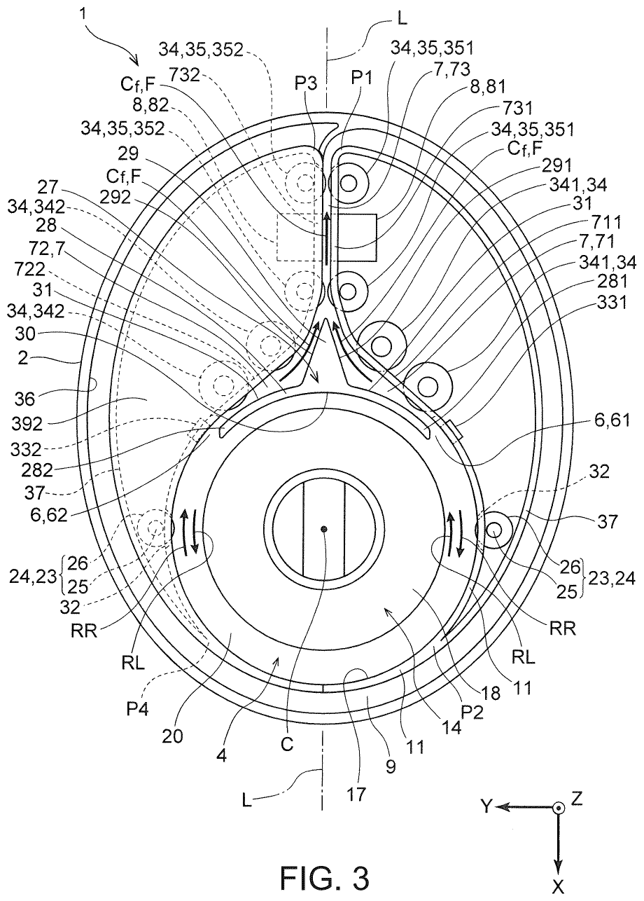

FIGS. 2 and 3 show a state in which one of the first covers 391 is removed.

As shown in FIGS. 2 and 3, in the present embodiment, as described above, the reading section 8 includes the first reading section 81 that reads the image on the first surface of the document 3, and the second reading section 82 that reads the image on the second surface of the document 3, which is opposite to the first surface.

In addition, in plan view, the first reading section 81 and the second reading section 82 are arranged symmetrically with respect to the straight line L passing through the third transport path 73, and the first transport path 71 and the second transport path 72 are arranged line-symmetrically. Further, the center C of the cylindrical set guide 14 is arranged so as to be positioned on the straight line L.

The first reading section 81 and the second reading section 82 are equipped with image reading sensors (contact image sensor: CIS) as process sections for performing image reading processing, and they have a shape that is elongated in the Z-axis direction as shown in FIG. 4. The image of the transported document 3 is read when passing through the reading position of the CIS.

### Description of Image Reading Operation by Image Reading Device of First Embodiment

(1) As shown in FIG. 5, the document 3, in a rolled state, is set by inserting the document 3 into the document setting section 4 of the image reading device 1 from above. The set document 3 spreads out toward the inner surface 17 of the peripheral wall 11 and the concave surface 30 of the entrance forming member 27 positioned around the document 3 by the restoring force. Then, it is in a state in contact with the inner surface 17, the rotation applying section 23, and the concave surface 30.

(2) Next, a reading start switch (not shown) is turned on. By this, the rotation roller 24 of the rotation applying section 23 starts to rotate, and the counterclockwise rotational force RL is applied to the set document 3 for a predetermined time in the present embodiment. When the reading start switch is turned on, the first transport roller 341, the second transport roller 342, and the third transport roller pair 35 constituting the transport section 34 also start to rotate.

(3) When the winding direction of the set document 3 is the left-wound roll shown in FIG. 2, in other words, when the winding direction is the counterclockwise direction, the leading edge 5 of the document 3 moves toward the first entrance 61 by the rotational force RL and enters the first entrance 61 within the predetermined time.

(4) The entry of the leading edge 5 into the first entrance 61 is detected by the first detection section 331, and the document 3 receives the transport force Cf from the first transport roller 341, which forms a part of the transport section 34, and is transported in the transport direction F on the first transport path 71. That is, the document 3 is transported in the transport direction F by receiving the transport force Cf and the rotational force RL.

(5) Subsequently, the document 3 is transported in the transport direction F through the third transport path 73 by receiving the transport force Cf from the third transport roller pair 35. At this time, the document 3 is transported in the transport direction F on the transport path 7 by receiving the transport force Cf from the third transport roller pair 35, the transport force Cf from the first transport roller 341, and the rotational force RL from the rotation applying section 23.

(6) When the document 3 is transported along the third transport path 73, the first reading section 81 and the second reading section 82 read the image of the document 3. The third transport path 73, through which the image of the document 3 is read, is configured to transport the document 3 with high accuracy based on the position information of the leading edge 5 of the document 3 sensed by the document detection section. The document detection section is provided at the entrance of the third transport path 73 as described above.

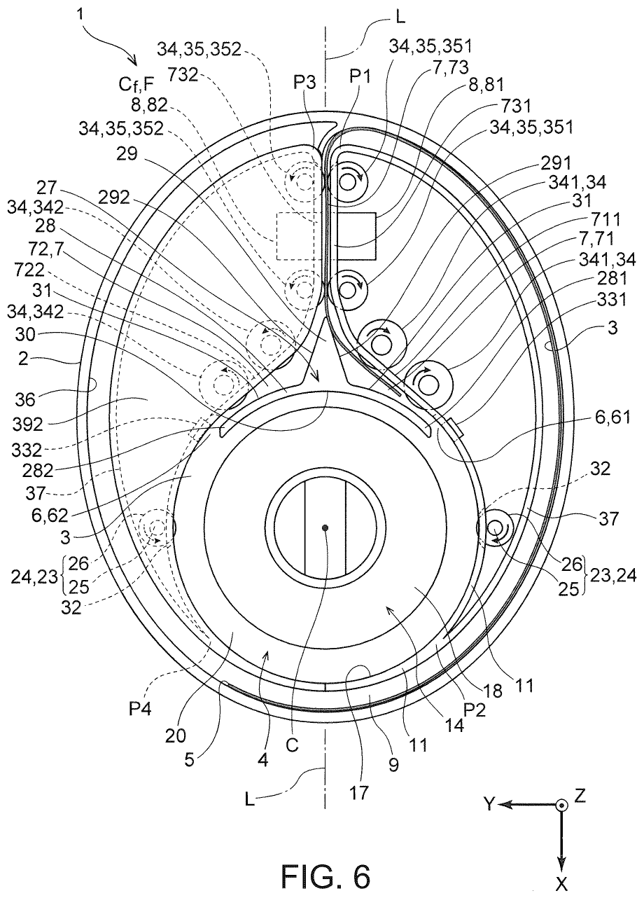

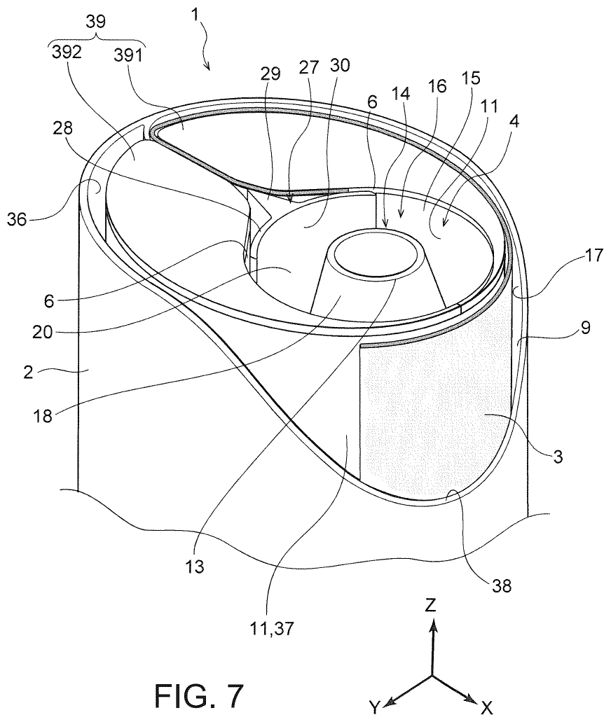

(7) The document 3, the image of which has been read in the third transport path 73, is sent to the discharge section 9. FIGS. 6 and 7 show a state in which the leading edge side of the document 3 is in the discharge section 9, but the rear end of the document 3 is still in the first transport path 71 and the third transport path 73.

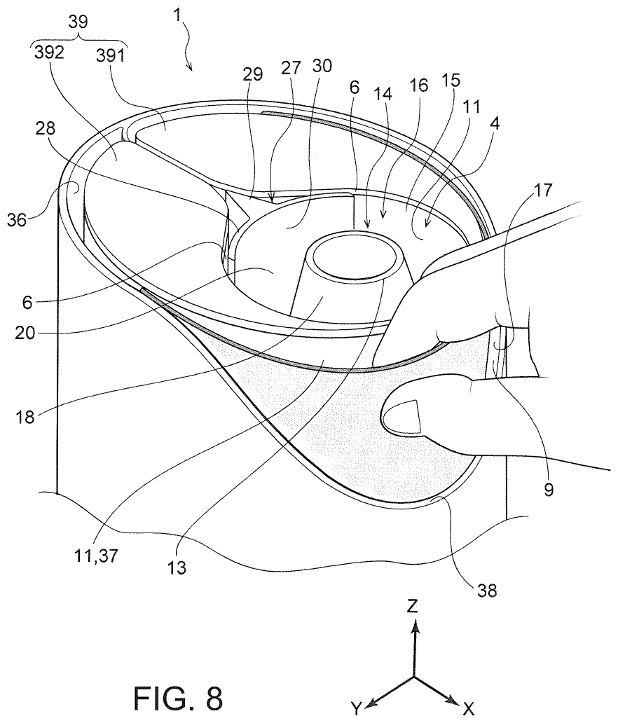

(8) When the trailing end of the document 3 passes through the third transport path 73, the entire document 3 is discharged to the discharge section 9. FIG. 8 shows a state in which the document 3 discharged to the discharge section 9 is lifted upward at the retrieval section 38 and is about to be taken out.

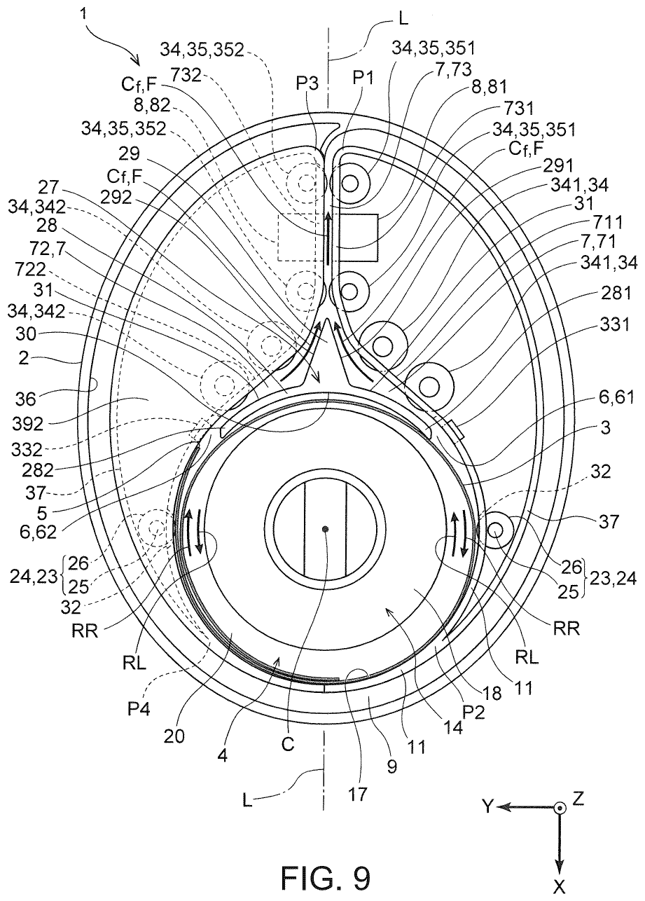

(9) In step (3), when the winding direction of the set document 3 is the right-wound shown in FIG. 9, in other words, when the winding direction is the clockwise direction, the document 3 is rotated by the rotational force RL, but both the first detection section 331 and the second detection section 332 are in the non-detection state even after the predetermined time has elapsed. Based on this non-detection state, the state of applying the initial rotational force RL to the document 3 is switched to the state of applying the rotational force RR in the opposite direction to the rotational force RL.

(10) The leading edge 5 of the document 3 is moved toward the second entrance 62 by the rotational force RR and enters the second entrance 62 within the predetermined time.

(11) The entry of the leading edge 5 into the second entrance 62 is detected by the second detection section 332, and the document 3 receives the transport force Cf from the second transport roller 342, which forms a part of the transport section 34, and is transported in the transport direction F on the second transport path 72.

(12) The subsequent steps are the same as steps (5) to (8) described above.

In the present embodiment, in step (2), the counterclockwise rotational force RL is set to be applied from the rotation roller 24 to the set document 3 for a predetermined time, but the opposite clockwise rotational force RR may be set to be applied for a predetermined time.

In this case, in step (3), since the leading edge 5 of the document 3 does not enter the first entrance 61 within the predetermined time, the state is switched to the state in which the rotational force RL in the opposite direction to the rotational force RR is applied after the predetermined time has elapsed.

Then, the leading edge 5 of the document 3 is moved toward the first entrance 61 by the rotational force RL, and enters the first entrance 61 within the predetermined time. The subsequent steps are the same as steps (4) to (8).

### Description of Effects of First Embodiment

(1-1) The image reading device 1 of the present embodiment includes the cylindrical document setting section 4 that is arranged in a tubular-shaped housing 2 and in which is set the document 3 wound in the cylindrical shape. In other words, the document setting section 4 is formed in a cylindrical shape. Further, the document 3 is not in a flat state but in a state of being wound in a cylindrical shape and is set in the cylindrical document setting section 4.

By this, since the document 3 is set in the cylindrical document setting section 4 in a state of being wound in a cylindrical shape, a region for the document to be set as in the case as in the related art, is not required and an operation region can be reduced. The document 3 in a state of being set in the document setting section 4 is not in a cantilever state as in the related art, but is supported over the entire document 3, and thus the posture of the document 3 is stable, and support by a user as in the related art is not required.

(1-2) Further, the document 3 set in the document setting section 4 is rotated by receiving the rotational forces RL and RR, so that the leading edge 5 of the document 3 in the rotation direction is advanced into the document leading edge inlet 6. The document 3 that has entered the document leading edge inlet 6 is further subjected to the transport force Cf and transported in the transport direction F along the transport path 7, and the reading section 8 reads the image of the document 3. The transport path 7 and the reading section 8 are arranged in the tubular-shaped housing 2, similarly to the document setting section 4. This reduces the operation region of the entire image reading device 1.

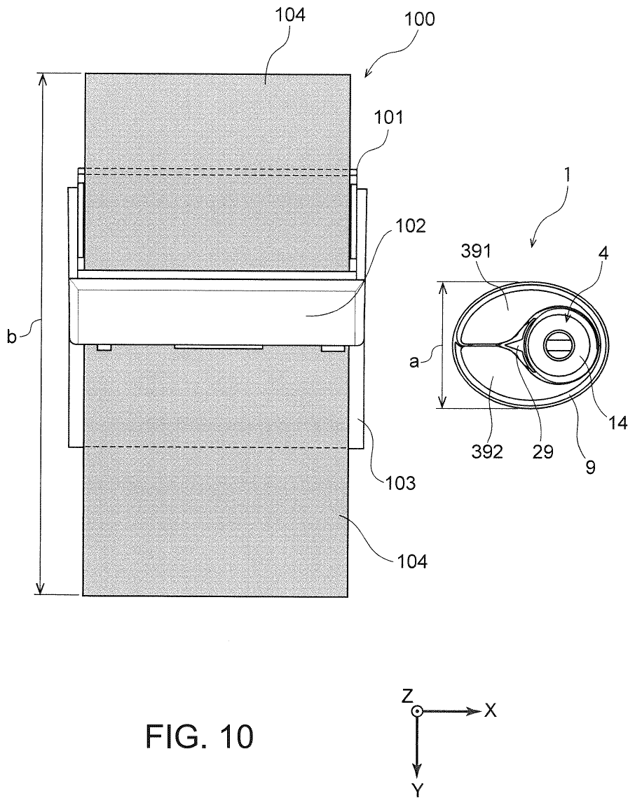

FIG. 10 is a plan view showing that the operation region of the entire image reading device 1 can be reduced. A normal image reading device 100 is shown on the left side of the image reading device 1 of the present embodiment. The image reading device 100 includes a document setting section 101, an image reading section 102, and a document discharge section 103. A flat document 104 is set in a flat state on the document setting section 101. The document 104 is transported by a transport section (not shown), an image is read by the image reading section 102, and the document is discharged in a flat state to the document discharge section 103.

It is easily understood that the image reading device 1 of the present embodiment can reduce the entire operation region as compared with the normal image reading device 100. For example, by comparing the dimension a and the dimension b along the Y axis, it can be easily understood that the image reading device 1 of the present embodiment can reduce the entire operation region as compared with the normal image reading device 100.

(2) In the present embodiment, the housing 2 is formed in a cylindrical shape. By this, by designing the cylindrical shape of the housing 2 along the cylindrical shape of the document setting section 4, it is possible to suppress the occurrence of wasted space and reduce the operation region of the entire image reading device 1.

(3) In the present embodiment, the discharge section 9 is located outside the document setting section 4 and along the inner surface 36 of the housing 2, and the document 3 discharged to the discharge section 9 is curved along the inner surface 36 of the housing 2. That is, the discharge section 9 is provided along the inner surface 36 inside the cylindrical housing 2, not outside the housing 2. This eliminates the need for a region for the document to be discharged to the discharge section 9 outside the housing 2, thereby further reducing the operation region.

(4) In the present embodiment, the document 3 discharged to the discharge section 9 can be taken out from the retrieval section 38. This facilitates the removal of the document 3 discharged to the discharge section 9.

(5) In the present embodiment, the retrieval section 38 is formed by the upper side to the lower side of the housing 2 being absent in a curved shape. By this, the document 3 discharged to the discharge section 9 is formed with the exposure region with a curved shape, so that the document 3 is more easily taken out.

(6) In the present embodiment, the document setting section 4 includes the cylindrical peripheral wall 11, the set guide 14 arranged inside the peripheral wall 11, and the set opening 16 for inserting the document 3. By this, the document 3 in a state of being wound in a cylindrical shape can be inserted into the document setting section 4 from the set opening 16 so that the set guide 14 is positioned at the center of the cylindrical document 3, and therefore, the user can easily set the document 3.

The document 3 in a state of being wound in a cylindrical shape is set in the region 20 between the set guide 14 and the peripheral wall 11 by being inserted from the set opening 16. The document 3 in the state of being wound in a cylindrical shape tends to return to a flat state by a restoring force unless there is something that maintains the wound state. Therefore, the document 3 in the set state spreads out toward the inner surface 17 of the peripheral wall 11 by the restoring force from being wound in the cylindrical shape and is in a state of being in contact with the inner surface 17 of the peripheral wall 11. By this, the set state of the document 3 set in the document setting section 4 is stabilized, and the document 3 is rotated in the stabilized state, so that the leading edge 5 can be made to enter the document leading edge inlet 6.

(7) The gap G (see FIG. 4) between the set guide 14 and the inner surface 17 of the peripheral wall 11 decreases from one side to the other side. In the present embodiment, the gap G decreases from top to bottom. In other words, the set guide 14 is configured such that the outer diameter of the upper section 13 is small, and the outer diameter increases toward the lower section 12. This makes it easier to insert the cylindrically rolled document 3 from the set opening 16 towards the bottom section 19, as the outer diameter of the upper section 13 of the set guide 14 is small. Because the outer diameter of the set guide 14 increases towards the lower section 12, the document 3 inserted in a state of surrounding the set guide 14 receives a force in a direction in which the diameter of the cylindrically rolled document 3 is increased by the increase in the outer diameter of the set guide 14, that is, a force in a spreading direction. This makes it easier for the outer peripheral surface of the document 3 wound in a cylindrical shape to come into contact with the inner surface 17 of the peripheral wall 11.

(8) In the present embodiment, the document leading edge inlet 6 includes the first entrance 61 and the second entrance 62 into which the leading edge 5 of the document 3 enters according to the winding direction of the document 3. By this, the user can put the document 3 into the document setting section 4 without caring about the winding direction of the document 3 wound in a cylindrical shape, and thus handling is easy.

(9) In the present embodiment, the rotation applying section 23 can apply the rotational forces RL and RR in both the counterclockwise direction and the clockwise direction to the document 3 in a state of being set in the document setting section 4. Then, the leading edge 5 of the document 3 rotated by the rotation applying section 23 enters the first entrance 61 or the second entrance 62. This allows the user to insert the document 3 into the document setting section 4 without caring about the winding direction of the document 3 in its cylindrically rolled state, enabling the leading edge 5 of the document 3 to enter the first entrance 61 or the second entrance 62 through the rotation applied by the rotation applying section 23.

The document 3 is set in the document setting section 4, and the rotational forces RL and RR are applied from the rotation applying section 23 in a stable state in which the document 3 is in contact with the inner surface 17 of the peripheral wall 11. That is, since the document 3 receives the rotational forces RL and RR from the rotation applying section 23 in a state where the document 3 is stable in the document setting section 4, the rotational forces RL and RR are more effectively transmitted to the document 3, and the document 3 smoothly enters the document leading edge inlet 6.

(10) In the present embodiment, the first detection section 331 is provided at the first entrance 61, and the second detection section 332 is provided at the second entrance 62. When both the first detection section 331 and the second detection section 332 are in the non-detection state after a predetermined time has elapsed from the application of the counterclockwise or clockwise rotational forces RL or RR to the document 3, the direction of the rotational forces RL or RR is controlled to be switched to the opposite direction. By this, the user can automatically cause the leading edge 5 of the document 3 to enter the first entrance 61 or the second entrance 62 by the rotation of the rotation applying section 23 by inputting the document 3 into the document setting section 4 without caring about the winding direction of the document 3 in a state of being wound in a cylindrical shape.

(11) In the present embodiment, the downstream end of the first transport path 71 in the transport direction F and the downstream end of the second transport path 72 merge together to form the third transport path 73, and the reading section 8 is arranged on the third transport path 73. By this, the leading edge 5 of the document 3 in a state of being wound in a cylindrical shape enters the first entrance 61 or the second entrance 62 according to the winding direction, but the first transport path 71 and the second transport path 72 merge so that it is transported through the third transport path 73, which is a common transport path. Therefore, the image reading device 1 can be downsized as compared with a configuration in which a transport path is arranged for each winding direction of the document 3.

The reading section 8 reads an image of the document 3 transported along the third transport path 73, which is the common transport path. By this, both the document 3 entering from the first entrance 61 and the document 3 entering from the second entrance 62 are read by the reading section 8 when being transported on the third transport path 73. That is, the image reading of the document 3 entering from the first entrance 61 and the image reading of the document 3 entering from the second entrance 62 can be performed under the same condition.

(12) In the present embodiment, the first reading section 81 and the second reading section 82 are arranged symmetrically with respect to the straight line L passing through the third transport path 73, the first transport path 71 and the second transport path 72 are arranged symmetrically with respect to the straight line L, and the center C of the cylindrical set guide 14 is located on the straight line L in plan view. By this, the document 3 is arranged symmetry with respect to the winding direction of the document 3, that is, as either the left-wound or the right-wound roll, and therefore, the transportability of the document 3 can be stabilized.

### Second Embodiment

Next, the image reading device 1 according to a second embodiment will be described with reference to FIG. 2.

The image reading device 1 of the present second embodiment is different from the first embodiment in that the rotation applying section 23 that applies the rotational forces RL and RR to the document 3 set on the document setting section 4 is not provided. That is, the present embodiment corresponds to a structure in a state where the rotation applying section 23 is removed from FIG. 2.

In the present embodiment, the rotational forces RL and RR are manually applied to the document 3 in the set state. The description of the other configurations and the corresponding operational effects is the same as that of the first embodiment.

Specifically, when the document 3 is set in the document setting section 4 as a left-wound roll (FIG. 2), after the reading start switch is turned on, the user manually applies a counterclockwise rotational force RL to the document 3. By this, the leading edge 5 of the document 3 enters the first entrance 61.

When the document 3 is set in the document setting section 4 as a right-wound roll (FIG. 9), a clockwise rotational force RR is manually applied to the document 3 by the user. By this, the leading edge 5 of the document 3 enters the second entrance 62.

The description after the leading edge 5 of the document 3 enters the first entrance 61 or the second entrance 62 is the same as that in the first embodiment, and thus the description thereof will be omitted.

Even in a structure not including the rotation applying section 23, effects other than the effects obtained by the rotation applying section 23 can be obtained similarly to the first embodiment.

### Third Embodiment

Next, the image reading device 1 according to a third embodiment will be described with reference to FIG. 2.

In the first embodiment, the document leading edge inlet 6 includes the first entrance 61 and the second entrance 62 so as to be able to cope with both the left-wound and the right-wound roll of the document 3. However, in the present embodiment, unlike the first embodiment, not both of the first entrance 61 and the second entrance 62 are provided as the document leading edge inlet 6. That is, the present embodiment corresponds to a structure in a state where one of the first entrance 61 and the second entrance 62 is removed from FIG. 2.

In the image reading device 1 according to the present embodiment, when the structure including only the first entrance 61, the rotation applying section 23 is configured to apply only the counterclockwise rotational force RL to the document 3. In this structure, the user sets the rolled document 3 in the document setting section 4 as a left-wound roll. The set document 3 moves by receiving the rotational force RL, and the leading edge 5 enters the first entrance 61.

On the other hand, when the structure including only the second entrance 62, the rotation applying section 23 is configured to apply only the clockwise rotational force RR to the document 3. In this structure, the user sets the rolled document 3 in the document setting section 4 so that the document 3 is as a right-wound roll. The set document 3 moves by receiving the rotational force RR, and the leading edge 5 enters the second entrance 62.

The description after the leading edge 5 of the document 3 enters the first entrance 61 or the second entrance 62 is the same as that in the first embodiment, and thus the description thereof will be omitted. The rotational forces RL and RR may be manually applied to the document 3 as in the second embodiment.

Even in a structure where only one of the first entrance 61 and the second entrance 62 is provided as the document leading edge inlet 6, the effects other than those obtained in the structure where both are provided can be obtained in the same manner as the first embodiment.

### Other Embodiments

The image reading device 1 according to the present disclosure basically has the configuration of the embodiment described above, but it is of course possible to change or omit a partial configuration without departing from the gist of the present disclosure

In the above embodiment, the set guide 14 is described as having a conical shape, but the shape is not limited to a conical shape. The shape may be a pyramid such as a triangular pyramid or a quadrangular pyramid, a cylinder having a uniform diameter, a prism, or the like.

To make the image reading device 1 less likely to fall over, the image reading device 1 may be configured such that the diameter of the lowermost surface is larger than that of the upper side components, in addition to or instead of lowering the centroid.

What is claimed is:

1. An image reading device comprising:
a tubular-shaped housing;
a cylindrical document setting section that is disposed in the housing and in which is set a document wound in a cylindrical shape;
a document leading edge inlet into which a leading edge of the document set in the document setting section advances in a rotation direction of the document by rotating due to receiving rotational force;
a transport path that is disposed in the housing and along which the document that advanced through the document leading edge inlet is transported in a transport direction by receiving a transport force;
a reading section configured to read an image of the document transported along the transport path; and
a discharge section from which the document read by the reading section is discharged.

2. The image reading device according to claim 1, wherein
the housing has a cylindrical shape.

3. The image reading device according to claim 2, wherein
the discharge section
is located outside the document setting section, extends along an inner surface of the housing, and
includes the inner surface of the housing as part of its structure,
so that the document to be discharged is curved along the inner surface of the housing.

4. The image reading device according to claim 3, wherein
the discharge section
is formed with a retrieval section by a part at an upper side of the housing being absent and
is configured to enable retrieval of the document discharged to the discharge section via the retrieval section.

5. The image reading device according to claim 4, wherein
the retrieval section is formed by an upper side to a lower side of the housing being absent in a curved shape.

6. The image reading device according to claim 1, wherein
the document setting section includes
a cylindrical peripheral wall,
a set guide arranged inside the peripheral wall and protruding upward, and
a set opening that is located between an upper section of the set guide and an upper section of the peripheral wall and through which the document is inserted toward a bottom section and
the document wound in a cylindrical shape is set in a region between the set guide and an inner surface of the peripheral wall by being inserted into the set opening and advances into the document leading edge inlet by receiving the rotational force.

7. The image reading device according to claim 6, further comprising:
a rotation applying section that applies the rotational force to the document set in the document setting section.

8. The image reading device according to claim 6, wherein
a gap between the set guide and the inner surface of the peripheral wall decreases from one end of the set guide to an other end.

9. The image reading device according to claim 1, wherein
the document leading edge inlet includes a first entrance and a second entrance through which the document enters depending on a direction in which the document is wound when the document is rotated by receiving the rotational force.

10. The image reading device according to claim 9, further comprising:
a rotation applying section configured to apply a rotational force in both clockwise and counterclockwise directions to the document set in the document setting section, wherein
the leading edge of the document rotated by the rotation applying section enters the first entrance or the second entrance.

11. The image reading device according to claim 10, wherein
the first entrance includes a first detection section that detects entry of the leading edge of the document,
the second entrance includes a second detection section that detects entry of the leading edge of the document, and
when both the first detection section and the second detection section are in a non-detection state at a point in time when a predetermined time elapses after the clockwise or counterclockwise rotational force is applied to the document, then direction of the rotational force is controlled to switch to the opposite direction.

12. The image reading device according to claim 9, wherein
the transport path includes
a first transport path having the first entrance and
a second transport path having the second entrance,
a downstream end of the first transport path and a downstream end of the second transport path merge in the transport direction to form a third transport path, and
the reading section is arranged on the third transport path.

13. The image reading device according to claim 12, wherein
the reading section includes
a first reading section configured to read an image on a first surface of the document and
a second reading section configured to read an image on a second surface of the document, and
in plan view with respect to a straight line passing through the third transport path,
the first reading section and the second reading section are disposed to be line symmetric,
the first transport path and the second transport path are disposed to be line symmetric, and
a center of the cylindrical set guide is located on the straight line.
